(19) United States
(12) Patent Application Publication
(10) Pub. No.: US 2008/0106040 A1
(43) Pub. Date: May 8, 2008

(54) Multimember Extended Range Compressible Seal

(76) Inventors: Clyde R. Zielke, Rockledge, FL (US); Frank Ruggieri, Merritt Island, FL (US); Dana M. Antes, Merritt Island, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/836,970

(22) Filed: Aug. 10, 2007

Related U.S. Application Data
(60) Provisional application No. 60/836,867, filed on Aug. 10, 2006.

(51) Int. Cl. F16J 15/50; F02F 11/00; F02C 7/28

(52) U.S. Cl. 277/315; 277/593; 244/53 R

(57) ABSTRACT

A seal assembly including a resilient carrier containing a seal and compression spring or compression member to enhance the load capacity range and load deflection range of the seal assembly by employing the compression spring/compression member and the resilient carrier to provide seal loading force and to allow seal deflection when under load, whereby the seal assembly accommodates either greater wear of the contact surfaces of the seal without exceeding predefined spring/compression member deflection limitations or accommodates larger tolerances in the fabrication, assembly, installation, and operation of the seal assembly, the U-shaped seal recess or seal housing in which the carrier is installed, and the machining of the adjacent sealing surfaces.

### CROSS-REFERENCE TO RELATED APPLICATIONS

This application claims the benefit of provisional patent application Ser. No. 60/836,867, filed Aug. 10, 2006, the disclosure of which is hereby incorporated by reference herein.

### BACKGROUND OF THE INVENTION

1. Field of the Invention

This invention relates to seals. More particularly, this invention relates to the seals used for sealing a flat, round or curvilinear surface or edge to a corresponding member allowing sealing movement therebetween.

This invention also relates to methods for using seal configurations and seal materials to provide selective loading of seals depending upon seal working conditions including, but not limited to, changes in temperature, pressure, concentration, density, or consistency of the working fluid, or changes in the physical condition of the end item, device, or machine in which the seal is being used.

2. Description of the Art Related to the Invention

Presently, there exist many types of seals designed to allow one surface to sealingly engage against another surface. Many of these types of seals function to allow movement between the surfaces, such as rotary lateral or linear translational movement, while still maintaining the sealing engagement of the surfaces.

For illustration, FIGS. 1 and 1A show a typical seal application, which utilizes the seal assembly 10 of this invention, that would be commonly found in a scroll compressor or expander. FIG. 1A provides a close up view of the seal assembly 10 installed in the elongated seal recess or seal housing 11 which is formed or machined in the scroll involute contact face 12, or upper edge, for housing the seal assembly 10. Also shown in FIG. 1A is the floor 13, or flat sealing surface for the seal assembly installed in the adjacent, or companion, scroll.

At the present time, most seals are designed to provide a positive seal that is maintained at a relatively constant working pressure over a limited range of working conditions. A typical seal configuration as shown in FIG. 2 utilizes a compression spring or compression member to maintain a constant, or nearly constant loading condition for a floating, or moving, seal.

There presently exists a need for improved seals which (1) provide a more compliant seal that can accommodate greater manufacturing tolerances, greater ranges in motion, or increased wear of the manufactured parts of mating components; (2) maintain improved sealing characteristics, or provide selective seal characteristics over a greater range of working conditions; (3) maintain close tolerance seal loading conditions when using the currently available softer seal materials which typically have higher wear rates than more conventional sealing materials; (4) maintain desired sealing characteristics over a wider range of working environments (pressures, temperatures, and the like) and working fluid consistencies (which can range from dry, high temperature gas vapor to very cold condensed liquids with entrained solids); and/or (5) maintain close tolerance loading conditions and tolerances over very long seal lengths (which are typical of the seal applications found in scroll expanders and compressors, large diameter pipes or ducts and ducted fan applications).

In addition, a need exists for seals which can provide active, real time, changes in the sealing characteristics, or seal loading, based upon real time changes in working fluid pressure, temperature, concentration, density, consistency, and the like; real time changes in the seal carrier materials (which are in turn the result of changes in the working temperature of the seal carrier materials or the associated device and its mating components; or the use of different, or alternative, working fluids having different physical or chemical attributes.

Therefore, it is an object of this invention to provide an improvement which overcomes the aforementioned inadequacies of the prior art seals and provides an improvement which is a significant contribution to the advancement of the seal art.

Another object of the invention is to provide a seal assembly comprising a seal, a compression spring or compression member supporting the seal and a resilient compressible carrier, of a generally square or rectangular (elongated) configuration which can easily and securely be installed into a generally U-shaped seal recess or seal housing without the need for using special assembly, installation, or retention fittings, tools or tooling.

Another object of the invention is to provide an apparatus and method for utilizing the compressibility of a highly compliant resilient compressible carrier containing a seal and compression spring or compression member to enhance the load capacity or load range of the seal assembly.

Another object of the invention is to provide an apparatus and method for utilizing the compressibility of a highly compliant resilient compressible carrier containing a seal and compression spring or compression member, to enhance the load deflection range of the seal assembly.

Another object of the invention is to provide an apparatus and method for utilizing the compressibility of a highly compliant resilient compressible carrier containing a seal and compression spring or compression member to enhance both the load capacity range and load deflection range of the seal assembly.

Another object of the invention is to provide an apparatus and method for enhancing the sealing properties of a highly compliant resilient compressible carrier containing a seal and compression spring or compression member to reduce fluid leakage under or around the backside of the seal or through the compression spring or compression member.

Another object of the invention is to provide an apparatus and method for utilizing the physical properties of a highly compliant resilient compressible carrier containing a seal and compression spring or compression member to adjust in real time the loading or deflection characteristics of the seal assembly based on at least one physical condition of pressure, temperature, density or concentrations of the working fluids exposed to the seal assembly.

Another object of the invention is to provide an apparatus and method for utilizing a highly compliant resilient compressible carrier to house and retain a seal and a compression spring or compression member to enhance assembly, installation, removal or handling operations such that the seal may be installed or removed without the use of specialized fittings, tools, or tooling.

Another object of the invention is to provide an apparatus and method for utilizing a highly compliant resilient compressible carrier to house and retain a seal and a compression spring or compression member to enhance assembly, installation, removal or handling operations whereby the seal assembly may be preassembled during manufacturing thereof and subsequently used fully-assembled to eliminate individual assembly, installation, removal or handling operations of the carrier, seal or compression spring or compression member during use.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objectives and a fuller understanding of the invention may be acquired by referring to the summary of the invention and the detailed description of the preferred embodiment in addition to the scope of the invention defined by the claims taken in conjunction with the accompanying drawings.

### SUMMARY OF THE INVENTION

For the purpose of summarizing the invention, this invention comprises a seal assembly for installation into a seal recess or seal housing. The seal assembly comprises a seal, a compression spring or compression member, and a resilient carrier. The compression of the resilient carrier provides a resilient carrier induced sealing force and the compression of the compression spring or compression member provides a compression spring or compression member induced sealing force. When installed into the seal recess, or seal housing, the combined sealing forces provided by the compression of both the resilient carrier and the compression spring or compression member urges the seal into sealing engagement with the mating component with which a seal is desired to be formed.

Preferably, the compression spring or compression member is positioned into the resilient carrier and the seal is positioned onto the compression spring or compression member. In this preferred arrangement, the sealing force of the resilient carrier is directly applied against the compression spring or compression member and the combined sealing forces induced by the resilient carrier and the compression spring or compression member are then applied to the seal.

The seal assembly is configured and dimensioned to fit into the seal recess or seal housing. For example, in the case of a generally square or rectangular seal recess or seal housing, the seal assembly correspondingly comprises a generally rectangular configuration and is dimensioned such that the seal, or sealing surface, extends above the rim of the seal recess or seal housing to provide the seal, or sealing surface, with the mating surface or component. In the case of an elongated rectangular seal recess or seal housing the seal assembly correspondingly comprises an elongated rectangular configuration.

In accordance with the invention, the sealing force produced by the compressibility of the resilient carrier itself enhances the load capacity or load range of the seal assembly over that which is produced by using only the compression spring or compression member to provide the sealing force. Further and more specifically, the sealing force produced by the compressibility of the resilient carrier combines with sealing forces produced by the compression spring or compression member and enhances, or increases, the load capacity as well as the deflection range that can be provided by the seal assembly. Consequently, the combined sealing forces, as produced by the resilient carrier and the compression spring or compression member, further enhances both the load capacity range of the seal assembly. The configuration of the seal and the combined sealing forces produced also reduces fluid leakage under or around the backside of the seal or through the compression spring or compression member. Another advantage provided by using both the resilient carrier and the compression spring or compression member to provide the sealing force to the seal is the ability to adjust in real time the loading or deflection characteristics of the seal based upon a change of at least one of the physical conditions (such as pressure, temperature, density concentration, or consistency and the like) of the working fluid being used; based upon the use of alternative, (or different), working fluids having different physical properties; or based upon changes in the physical condition (temperature and the like) of the material which is directly adjacent to the seal assembly or resilient carrier (which in turn reflect the physical condition of the device or machine in which the seal is being used).

This real time adjustment of the sealing force applied to the sealing surface is accomplished by selecting materials used in the resilient carrier which respond to the change in the physical conditions (i.e. expand or contract based upon the change in physical condition) which in turn will result in increased or decreased force applied to the seal.

The seal assembly of the present invention, which includes the resilient carrier, the compression spring or compression member and seal, are configured so they can be preassembled during the manufacturing process to provide a fully integrated seal assembly. This fully integrated seal assembly can then be installed into (or removed from) the seal recess or seal housing as a fully-assembled single unit, without the need for use of specialized fittings, tools, or tooling, which greatly reduces, or can even eliminate, the tedious and delicate operations required for assembling, installing, removing and handling prior art seals as part of the initial installation of the seal assembly into the end item or during seal assembly, installation, removal, or replacement efforts which may be required in subsequent field servicing or repair activities.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention reference should be made to the following detailed description taken in connection with the accompanying drawings in which:

FIG. 1 is a perspective view of a typical machined scroll, as would be used in a scroll expander or compressor, showing the seal assembly of the invention installed on the sealing edge, or tip, of the machined scroll involute;

FIG. 1A is a close up view of a machined scroll, as would be used in a scroll expander or compressor, showing a close-up view of the installed seal assembly of the invention;

FIGS. 2A and 2B are cross-sectional views of a prior art seal assembly respectively showing the prior art seal assembly in its relaxed, or unloaded, state (FIG. 2A) and in its loaded, or compressed, state (FIG. 2B) when mated to the component with which a seal is desired to be formed;

FIGS. 3A and 3B are cross-sectional views of a first embodiment of the seal assembly of the invention respectively showing the seal assembly in its relaxed, or unloaded, state (FIG. 3A) and in its loaded, or compressed, state (FIG. 3B) when mated to the component with which a seal is desired to be formed;

FIG. 4 is a partial cut-away view of a scroll involute, as would be found in a scroll expander or compressor, showing the manner in which the seal assembly of the invention is installed within the elongated seal recess or seal housing that is machined or formed in the edge of the scroll involute;

FIG. 5 is a diagrammatic view of a piston having a ring land showing the manner in which the seal assembly of the invention is installed within the ring land;

FIG. 6 is a diagrammatic view of a ducted fan having fan blades rotating within a duct showing the manner in which the seal assembly of the invention is installed within an elongated seal recess or seal housing which is machined or formed in the duct;

FIG. 7 is a partial cross-sectional view of an impeller rotating in a housing of a compressor or pump showing the manner in which the seal assembly of the invention is installed within an elongated seal recess or seal housing which is machined or formed in the housing;

FIG. 8 is a diagrammatic view of a pair of connected pipes showing the manner in which the seal assembly of the invention is installed within an elongated seal recess or seal housing which is machined or formed in the end of the outer pipe or duct;

FIGS. 9A-E are partial views showing various embodiments of the compression spring or compression member that may be employed in the seal assembly of the invention;

FIGS. 10A-K are partial views showing other embodiments of the compression spring or compression member that may be employed in the seal assembly of the invention;

FIGS. 11A-G are partial views showing various embodiments of the resilient carrier that may be employed in the seal assembly of the invention;

FIGS. 12A-D are cross-sectional views of various embodiments of the seal assembly of the invention showing the various arrangements of the carrier and compression spring or compression member relative to each other;

FIGS. 13A-D are cross-sectional views of various multiple carriers, compression springs or compression members and seals of the seal assembly of the invention installed within the U-shaped seal recess or seal housing;

FIG. 14 is a diagrammatic view showing various stacked arrangements of the carriers and compression springs or compression members of the seal assembly of the invention installed in the U-Shaped seal recess or seal housing;

FIG. 15 is a diagrammatic view showing various layered arrangements of the carriers of the seal assembly of the invention installed in the U-shaped seal recess or seal housing;

FIG. 16 shows dimensions of a typical elongated seal recess which would be used to house, or contain, the multimember compressible seal;

FIG. 17 shows a typical seal height for a typical uncompressed multimember compressible seal assembly;

FIG. 18 shows the dimensions of a typical resilient compressible carrier;

FIG. 19 shows a cross-section of a typical assembled multimember compressible seal reflecting both uncompressed (unloaded) and compressed (loaded) state, and the associated uncompressed and compressed dimensions;

FIG. 20 shows a typical spring load versus spring deflection (or compression) capabilities for a typical cant spring of the type that could be used as the compression spring or compression member of the invention;

FIG. 21 shows the extended seal loading and extended seal deflection capabilities provided by the multimember compressible seal using a cant spring as the compression spring or compression member;

FIG. 22 shows the addition of shims, to the multimember compressible seal, in order to increase, or adjust, seal contact surface loading; and

FIG. 23 shows the “as formed,” or “as molded,” configuration of the resilient compressible carrier which is used to house or retain the seal and spring or compression member.

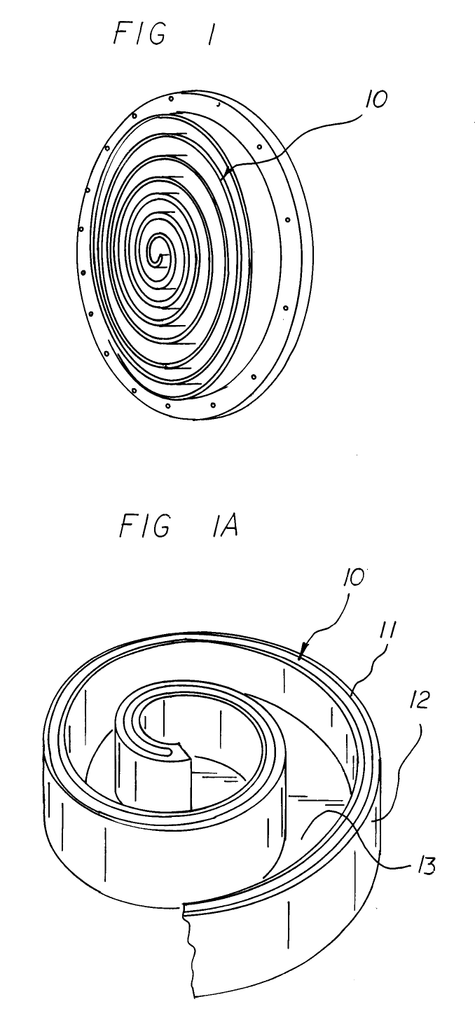

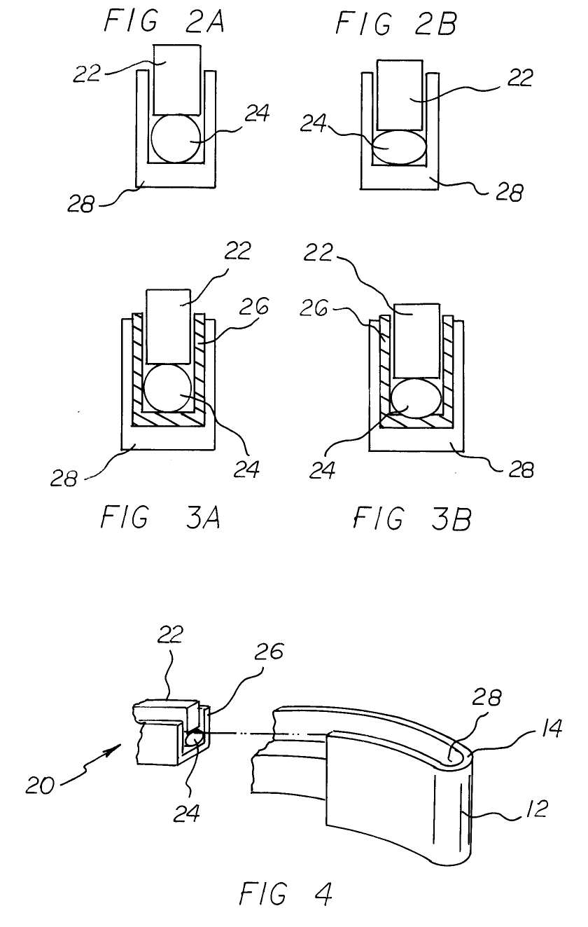

Similar reference characters refer to similar parts throughout the several views of the drawings.

### DETAILED DESCRIPTION OF THE PREFERRED EMBODIMENTS

### Configuration

Referring to FIGS. 3A and 3B, the multimember extended range compressible seal assembly 20 of the invention is comprised of a seal 22 supported by a compression spring 24 or compression member 24 and a resilient compressible carrier 26 in a stacked configuration. As shown in FIG. 4, the multimember extended range compressible seal assembly 20 is intended to be installed within a generally U-shaped elongated seal recess 28 or seal housing which is machined in a straight or curvilinear surface, such as along the upper edge 14 of a scroll involute 12.

### Features

The seal assembly 20 of the invention includes one or more features such as:

providing a high quality seal 20 which will significantly reduce fluid leakage (vapor and/or liquid) which occurs between the successive wraps (or expansion/compression chambers) of a scroll expander or compressor when conventional seals are utilized;

providing the capability to easily adjust the seal contact loads (and overall assembled seal height) without having to change out (or replace) the more costly seal 22 and compression spring 24 or compression member 24 components (i.e., seal contact pressure, and overall assembled seal height, can be adjusted by simply changing the dimensions of the low cost resilient compressible carrier 26);

maintaining a constant seal face contact working pressure along the entire length of the seal;

accommodating wear;

accommodating variations in seal thickness (or height) or the seal compression spring carrier recess or the hardware being sealed, manufacturing tolerances of the soft seal material (e.g., Rulon) while still maintaining the needed seal working surface (or face) contact pressures,

preventing “fluid blow-by” (both liquid and/or vapor) under (or around) the back side of the seal (the side opposite the seal working surface or contact face;

being easily fabricated and assembled using conventional materials and conventional fabrication techniques, or

being easily installed (into the seal recess or seal housing) and provide a positive means of retaining itself in the seal housing (during the initial seal installation into the seal recess or seal housing and during subsequent end item assembly, disassembly or repair activities) without the need for using special assembly, installation, or retention tools,

being assembled as a fully integrated seal assembly in order to eliminate the need to handle individual seal components during seal installation or removal from the end item in which the seal is being used,

providing the capability to adjust in real time seal loading or deflection characteristics based on a change in the physical condition of the working fluid or the device or machine in which the seal is being used.

### Application

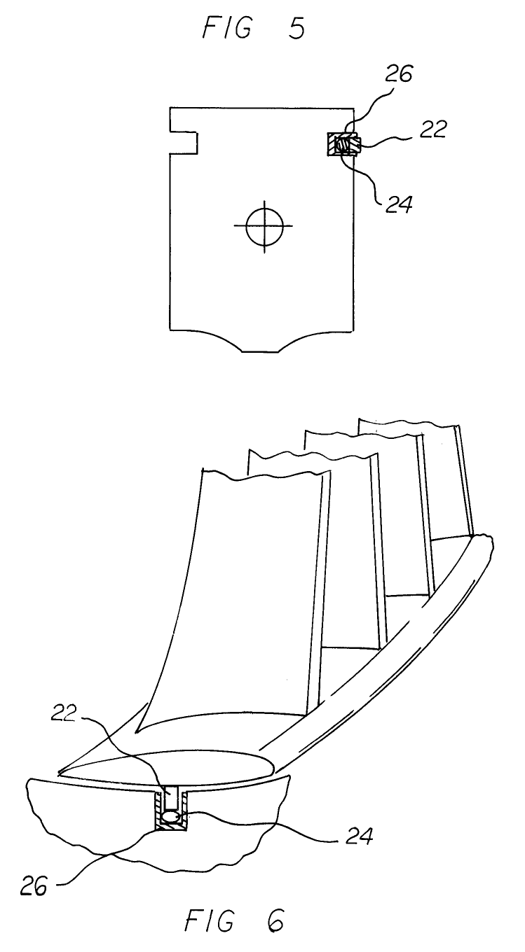

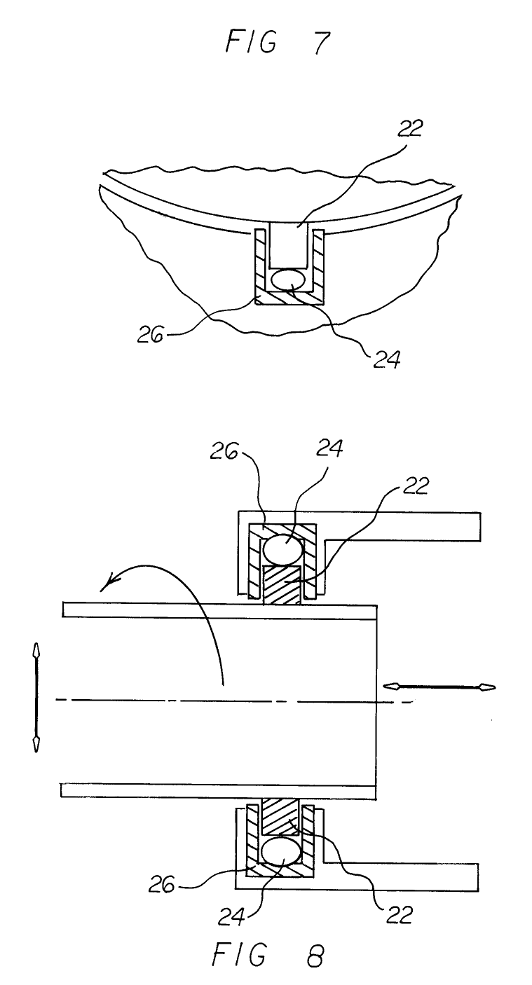

The seal assembly 20 of the invention may be used in many applications including but not limited to: (1) the seal used for sealing the upper edge 14 of a scroll involute 12 (FIG. 4); (2) the seal used in the ring land of a piston or free-piston engine, compressor, or similar device (FIG. 5); (3) the seal between the case and the rotating duct of a ducted fan or large rotating fan assembly (FIG. 6); (4) the seal between the rotating impeller and the case of a pump or compressor (FIG. 7); or (5) the seal between connecting or moving sections of large diameter pipes or ducts (FIG. 8).

### Configuration Alternatives

Referring again to FIGS. 3A and 3B, in one embodiment, the seal 22 comprises a generally square or rectangular cross-sectional configuration and is composed of a high-performance homogeneous bearing material, such as that composed of PTFE-based material, that is capable of withstanding harsh environments such as extreme pressures and temperatures, and exposure to fluids including: water, steam, refrigerants, and the like. One example of a high-performance homogeneous material that may comprise the seal 22 is that sold under the registered trademark “Rulon” by the Saint-Gobain Performance Plastics Corporation. Other seal cross-sectional configurations may also be used depending on specific application requirements or need.

The compression spring 24 or compression member 24 may be comprised of a variety of configurations that exert a force against the seal 22 to urge it into sealing engagement with the complementary surface to achieve a desired seal.

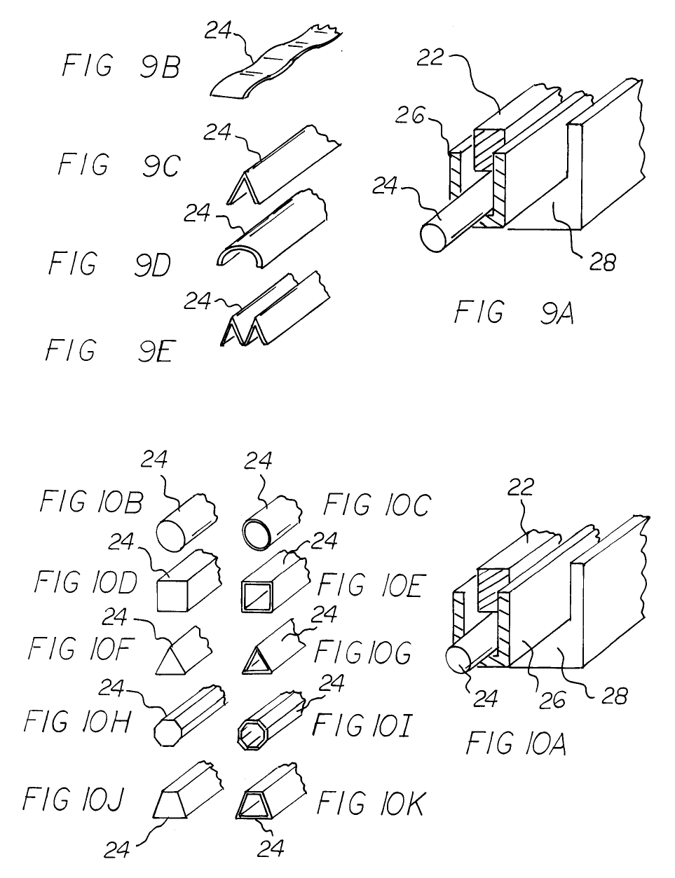

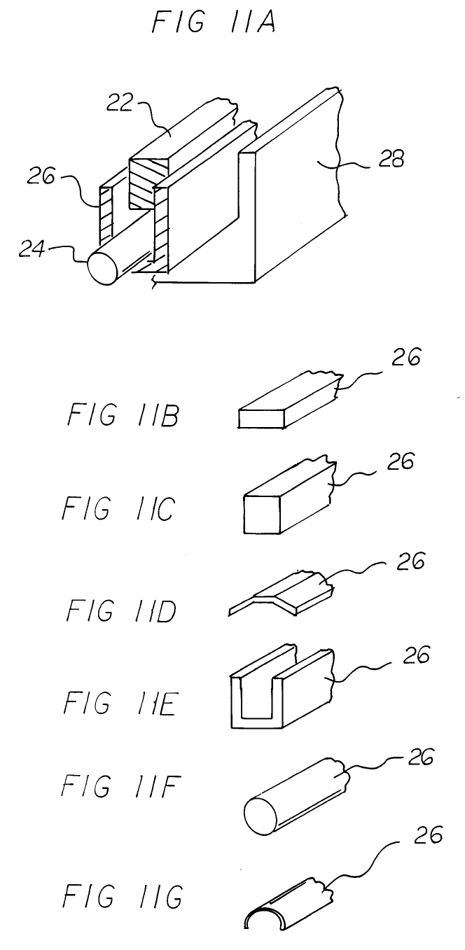

Referring to FIGS. 3A and 3B, the compression spring 24 or compression member 24 may be comprised of a horizontal coil, or cant spring. Any of a number of other compression spring 24 or compression member 24 configurations can be used, as shown in FIGS. 9A through 9E including, but not limited to, a wave spring (FIG. 9B), a V-shaped spring (FIG. 9C), U-shaped spring (FIG. 9D) or a W-shaped spring (FIG. 9E). Alternatively, as shown in FIGS. 10A through 10K, the compression spring 24 or compression member 24 may be comprised of round (FIGS. 10B and 10C), rectangular (FIGS. 10D and 10E), triangular (FIGS. 10F and 10G), octagonal (FIGS. 10H and 10I) or trimmed triangular configurations (FIGS. 10J and 10K), which can be fabricated from either solid (as shown in FIGS. 10B, 10D, 10F, 10H, and 10J) or hollow (as shown in FIGS. 10C, 10E, 10G, 10I, and 10K) resilient compressible materials. Other configurations including those disclosed in U.S. Pat. No. 7,055,812, the disclosure of which is hereby incorporated by reference herein or by references cited in U.S. Pat. No. 7,055,812, each of which is hereby incorporated by reference herein, may also be employed.

As shown in FIGS. 3A and 3B, in one embodiment, the resilient compressible carrier 26 is comprised of a generally U-shaped configuration dimensioned to fit within the seal recess 28 to receive the compression spring 24 or compression member 24 and seal 22. As shown in FIGS. 11A through 11G, the resilient compressible carrier 26 may alternatively comprise a generally rectangular cross-section (FIG. 11B), a square cross-section (FIG. 11C), a V-shaped cross-sectional (FIG. 11D), a U-shaped cross-sectional (FIG. 11E), a round cross section (FIG. 11F), a half-round cross-sectional (FIG. 11G), or any of a number of seal cross section configurations as may be appropriate based on specific application requirements or needs. The material constituting the resilient compressible carrier 26 preferably comprises a resilient compressible material, such as rubber, sufficient to provide additional support and an increased range of travel to the seal 22. It should be noted that hollow configurations, as previously discussed, can also be used in order to further modify, or tune, the load and compression characteristics of the resilient compressible carrier 26.

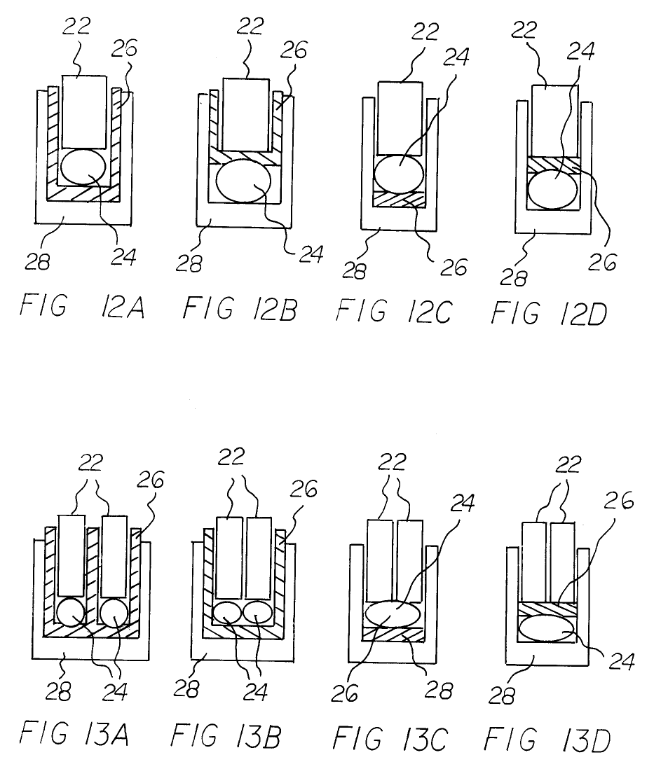

As shown in FIGS. 12A through 12D, the resilient compressible carrier 26 may be positioned in the U-shaped seal recess 28 under the compression spring 24 or compression member 24 (FIG. 12A) or between the compression spring 24 or compression member 24 and the seal 22 (FIG. 12B). More particularly, the embodiment of the resilient compressible carrier 26 constituting a generally U-shaped cross-sectional configuration may be positioned below (FIG. 12A) or above the compression spring 24 or compression member 24 (FIG. 12B). Alternatively, the resilient compressible carrier 26 comprising a generally square, rectangular or any other uniquely formed cross-sectional configuration may be positioned below the compression spring 24 or compression member 24 (FIG. 12C), or above the compression spring 24 or compression member 24 (FIG. 12D).

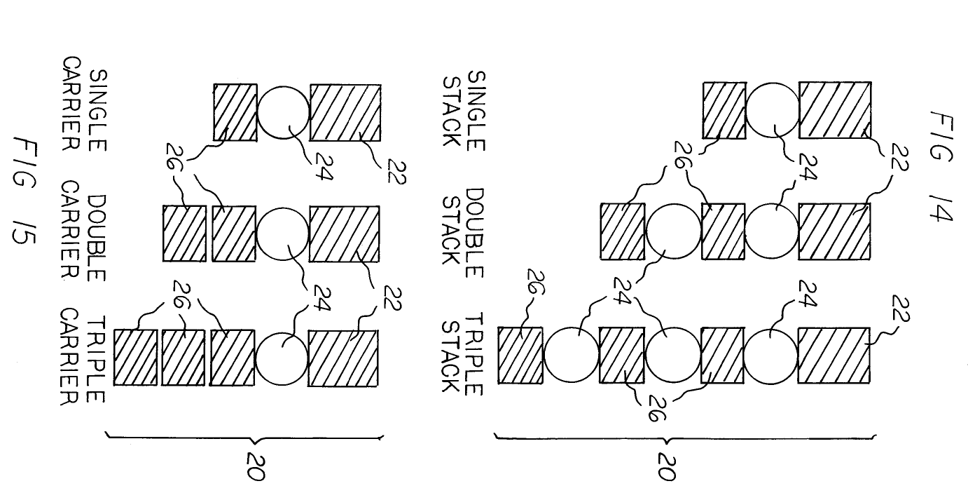

As shown in FIGS. 13A through 13D, combinations of seals 22 may be used with one or more compression springs 24 or compression members 24 or resilient compressible carriers 26 to provide increased sealing. Two or more seals 22 with their respective compression springs 24 or compression members 24 and a resilient compressible carrier 26, or carriers, may be positioned within the seal recess 28 or seal housing (FIG. 13A). Alternatively, two or more seals 22 and their respective compression springs 24 or compression members 24 may be supported within a single U-shaped resilient compressible carrier 26 (FIG. 13B). Further alternatively, two or more seals 22 supported by a single compression spring 24 or compression member 24 and a single square or rectangular cross section resilient compressible carrier 26 located above or below the compression spring 24 or compression member 24 can be used to provide the sealing needed (FIGS. 13C and 13D).

The various embodiments of the multimember extended range compressible seal assembly 20 of the invention are intended to provide a positive seal to prevent blow-by occurring under the seal 22. The resilient compressible carrier 26 extends the working travel range of the seal 22 over that provided by using only the compression spring 24 or compression member 24 while maintaining the seal compression loads at values that are equal, or nearly equal, to those provided by the compression spring 24 or compression member 24. The selection or adjustment of the combinations of the various embodiments, including the specific compression spring 24 or compression member 24 and the resilient compressible carrier 26 load-to-compression values provides the capability to adjust or select the seal loading rates as the function of the amount of depression or compression applied to the seal and the ultimate compression of the combination of the supporting compression spring 24 or compression member 24 and resilient compressible carrier 26.

Another embodiment of the invention utilizes multiple compression springs 24 or compression members 24 and resilient compressible carriers 26 to further enhance (or increase) the working range of the multimember extended range compression seal. This concept can be implemented using the stacked configurations shown in FIGS. 14 and 15. This concept can also be used as a means of interleaving compression springs 24 or compression members 24 and resilient compressible carriers 26 that are of different materials, and having selective expansion ratios and selective compressibility factors, to provide a greater range of adjusting the seal loading pressure based upon a wider range of working fluid conditions, or seal carrier physical conditions.

### Selective Sealing Applications

Another embodiment of the multimember extended range compressible seal assembly of the invention is intended to provide selective loading or sealing, of the sealing force being exerted, based upon the specific conditions of the seal working environment. In this embodiment, the materials, or the combination of materials, used for the compression spring 24 or compression member 24 and the resilient compressible carrier 26 are selected in order to provide the capability to adjust the pressure applied to the face of the seal 22 based upon the changes encountered in the seal working environment. In this way, it would be possible to maintain a high quality seal (with optimum seal contact pressures) under specific working conditions, and provide a relaxed seal 22 (or no seal at all) when the selected working conditions (which are required for the high quality seal) do not exist. This would provide the capability to actively adjust in real time the specific sealing characteristics of the seal assembly 20 based upon a change in at least one of the physical conditions (such as temperature, pressure, density, concentration or consistency) of the working fluid being used; or changes in the physical condition (temperature and the like) of the material which is adjacent to the seal assembly 20 or the seal carrier (which in turn can be used to reflect the physical condition of the device or machine in which the seal is being used).

The ability to selectively reduce, or even eliminate, seal loading based on the condition (largely the temperature, pressure, density, composition, or concentration) of the working fluid or the condition of the seal supporting materials also provides the opportunity to relieve, or reduce, seal loading during cold or hot start up conditions; and yet provide and maintain optimum seal loading conditions when nominal operating conditions are achieved. This approach provides the opportunity to reduce, or even eliminate, the increased seal friction loads which are typically encountered during start up, thereby providing the opportunity to significantly reduce typical start up loads. In addition, this approach provides the opportunity to increase the flow of the working fluid over the seal during hot or cold start up conditions, which in turn provides improved flow of lubrication across the seal during start up and which further helps to reduce seal start up friction loads and start up wear.

### Sealing Forces

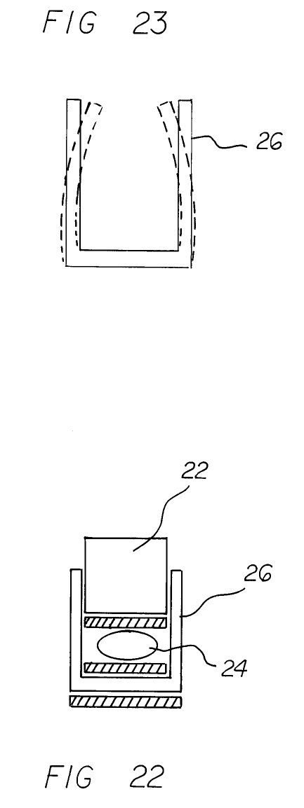

Sealing of the seal contact face, or the moving seal contact surface, is accomplished by the force (or pressure) that is applied to the seal 22 by the compression of both the compression spring 24 or compression member 24 and the resilient compressible carrier 26. This force, and the resulting seal contact face contact pressure, can be adjusted based upon the material properties and the thickness of the material used for the resilient compressible carrier 26, the size and spring properties of the compression spring 24 or compression member 24 that is used, and the thickness of the seal 22 used. Reducing (or increasing) the thickness of the resilient compressible carrier 26, or reducing (or increasing) the compression resistance of the resilient compressible carrier 26 will result in reduced (or increased) contact force applied to the seal face contact surface, Likewise, reducing (or increasing) the size of the compression spring 24 or compression member 24 or reducing (or increasing) the resistance of the compression spring 24 or compression member 24 (by selecting a lighter or heavier spring) will also reduce (or increase) the contact force applied to the seal face contact surface. Reducing (or increasing) the thickness of the seal will also reduce (or increase) the contact force applied to the seal face contact surface. It is also possible to adjust (increase or decrease) the force (or pressure) applied to the seal contact face by adding or removing shims or shim stock 29 that can be added to the seal assembly 20. This shim stock 29 can be added, as shown in FIG. 22, under the resilient compressible carrier 26, or above and below the compression spring 24 or compression member 24.

Seal leakage, or seal blow-by, around the back side (or underside) of a conventional seal or the seal assembly 20 is reduced or even prevented by the seal forces that are effected by the compression of the resilient compressible carrier 26 where the resilient compressible carrier 26 contacts the sides of the seal 22 and the walls and floor of the elongated seal recess 28 (which houses the seal assembly 20 in the edge of the scroll). The thickness and the type of the material used for the resilient compressible carrier 26, the dimensions and physical characteristics of the components which are housed in the carrier (the seal 22 and the compression springs 24 or compression members 24) and the dimensions of the elongated seal recess (which is used to house the assembled seal 22), will dictate the compression of the resilient compressible carrier 26 (which occurs at the installation of the seal 22) and the quality of the seal 22 that results (tight, close tolerance, fits will typically result in better sealing with lower leakage rates).

### Preassembly Attributes

The seal assembly 20, which comprises the seal 22, the compression spring 24 or compression member 24, and the resilient compressible carrier 26, is configured so that the seal assembly 20 can be preassembled and handled as an assembly (prior to and during installation or removal from the end item application). This allows the resulting seal assembly 20 to be handled, installed or removed as a single assembly thereby reducing the time and difficulty of the seal installation effort encountered during initial scroll assembly or subsequent scroll repair activities which require removal and reinstallation of the seal assembly 20. Assembly, or build-up, of the seal assembly 20 is accomplished by simply inserting the compression spring 24 or compression member 24 into the cavity of the resilient compressible carrier 26, and then installing the seal 22 on top of the compression spring 24 or compression member 24. The compression spring 24 or compression member 24 and the seal 20 are retained in the resilient compressible carrier 26 as the result of the retention loads that are placed on the sides of the installed seal assembly 26 as the result of the expansion (or separation) of the lips (or extensions) of the resilient compressible carrier 26 (which occurs during the installation of the compression spring 24 or compression member 24 and seal 20). It should be pointed out that the lips (or extensions) of the resilient compressible carrier 26 are slightly closer to each other at the top of the carrier than at the bottom, as shown in FIG. 23, as the result of the extrusion process that is used to form the resilient compressible carrier 26. This slight inward cant (or inward deformation) is sufficient to produce a light loading on the sides of the seal 22 and the compression spring 24 or compression member 24 which, in turn, is sufficient to retain the seal 22 and compression spring 24 in the resilient compressible carrier 26 prior to and during the installation of the seal assembly 20.

### Seal Retention

Retention of the seal assembly 20 in the elongated seal recess 28 or seal housing (after installation of the seal assembly 20 in the elongated seal recess 28 or seal housing), is provided by the compression loads and friction which are applied to the sides of the resilient compressible carrier 26 during the installation of the seal assembly 20, into the elongated seal recess 28 that houses the seal assembly 20. The compression loads are the result of compressing the sides of the expanded resilient compressible carrier 26 which were slightly deformed (or expanded outward) as the result of installing the seal 22 and the compression spring 24 or compression member 24 in the resilient compressible carrier 26. In addition, a lubricant, a soluble grease, or a soluble adhesive can also be used to coat the sides and bottom of the seal assembly 20 or seal assembly contact surfaces of the U-shaped elongated seal recess or seal housing, prior to installation of the seal assembly 20, in order to enhance (or increase) the retention of the seal assembly 20 in the seal recess or seal housing. It is also possible to apply a more permanent adhesive (or glue) to the resilient compressible carrier 26 (or the contact surfaces of the elongated seal recess or seal housing that houses the seal assembly 20) to achieve a more permanent installation if needed for a specific application.

### Specific Application

FIGS. 16-23 describe an embodiment of the seal assembly of the invention which was specifically designed to meet the sealing needs for a tip seal application of the type which is found in most scroll expander and compressor applications. Traditionally, scroll expander and scroll compressor operating efficiencies (or performance) have been much lower than desired due, in large part, to the lack of available high efficiency seals which would prevent fluid leakage between the successive wraps (or expansion/compression chambers) of the scroll. This is, in the most part, due to the need to provide a high quality, low drag seal along the entire length of each of the scroll tip contact surfaces which requires a very small cross section seal that will often be several feet in length.

The seal assembly 20 comprises the seal 22, the resilient compressible carrier 26, and the compression spring 24 or compression member 24. The seal assembly 20 is housed in the small (e.g., 0.133×0.133 inch) elongated seal recess 28 or seal housing that was machined in the upper (or outer) edge of both the moving and fixed scroll involutes or vertical walls.

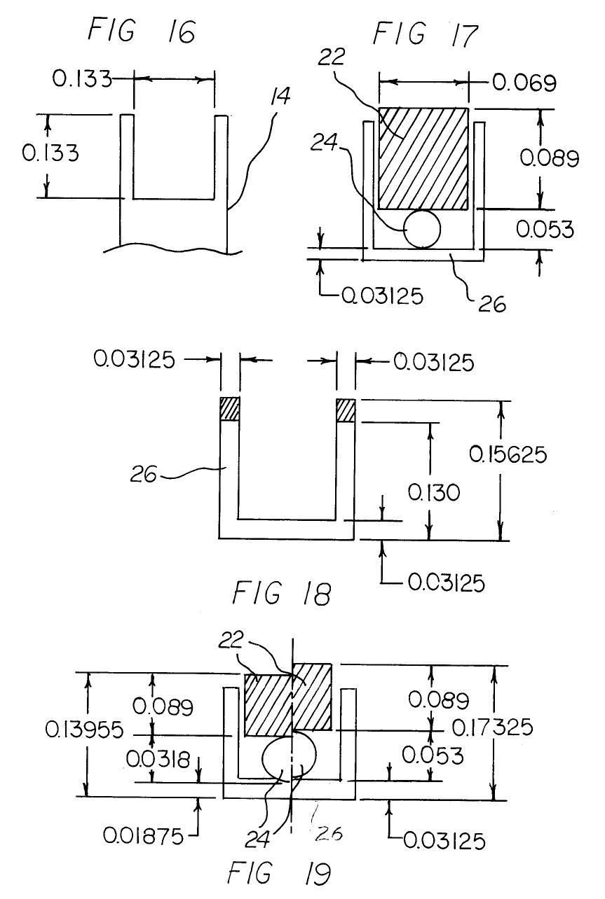

FIG. 16 shows a particular configuration of the elongated seal recess or seal housing that was machined in the upper edge of the scroll. FIG. 17 shows a cross section reflecting the uncompressed dimensions of the original seal assembly prior to installation in the elongated seal recess or seal housing. As shown in FIG. 17, the seal 22 was machined to its final dimension (e.g., 0.089 inches×0.069 inches×12 feet), from Rulon material manufactured by Saint Gobain Performance Plastics. The compression spring 24 used in this application was comprised a stock, off-the-shelf item (i.e., a compressible cant spring) manufactured by Bal Seal. The resilient compressible carrier 26 used in this application was fabricated from a standard rubber extrusion manufactured by Mid-Atlantic Rubber as shown in FIGS. 18 and 26. The resilient compressible carrier 26 dimensions were selected to provide a tight, slightly compressed fit when installed, as part of the assembled seal assembly 20, in the elongated seal recess or seal housing. This “tight fit” assured retention of the seal assembly 20 in the elongated seal recess or seal housing without the use of additional retention fittings, tools, or tooling.

It should be noted that the “U shaped” resilient compressible carrier 26 was designed such that leakage under the seal 22 was minimized (in this application the blow by was eliminated entirely). This was accomplished by carefully selecting (and controlling) the dimensions of the seal 22 and the resilient compressible carrier 26 to assure that the resilient compressible carrier 26 prevented (or eliminated) fluid leakage past the vertical edges of the seal 22 and the elongated edge of the scroll (which housed the seal assembly 20).

FIG. 18 includes exemplary dimensions for the resilient compressible carrier 26 (which was fabricated using an off-the-shelf rubber extrusion with only minor modifications, as required to reduce the overall height of the rubber extrusion from 0.15625 ( 5/32) inches to 0.133 inches as shown in FIG. 18.

FIG. 19 shows a cross section of the assembled seal 20 reflecting both its uncompressed (or unloaded) state (as shown on the right of FIG. 19) and the compressed (or loaded) state (as shown on the left side of FIG. 19) and applicable dimensions. The total compression, as provided by compression (or deformation under load) of both the compression spring 24 or compression member 24 and the resilient compressible carrier 26 exceed that which would be provided if only the compression spring 24 or compression member 24 deformation (or compression) were utilized (or allowed).

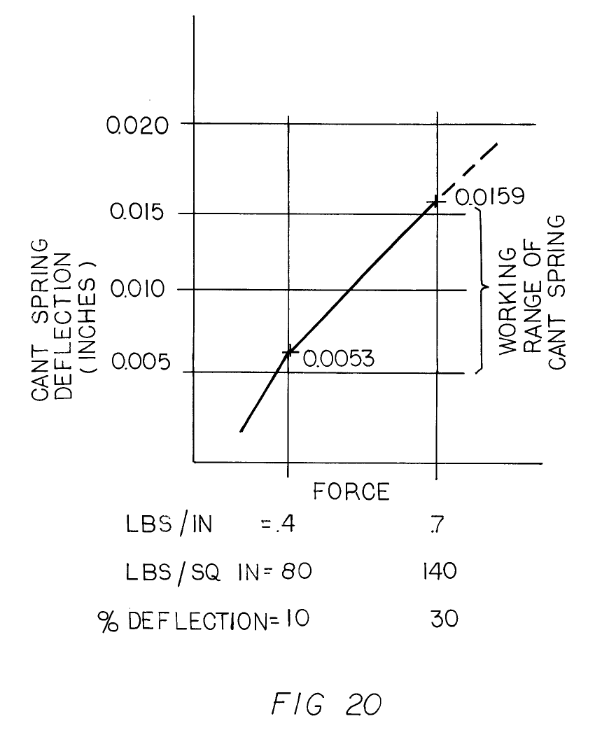

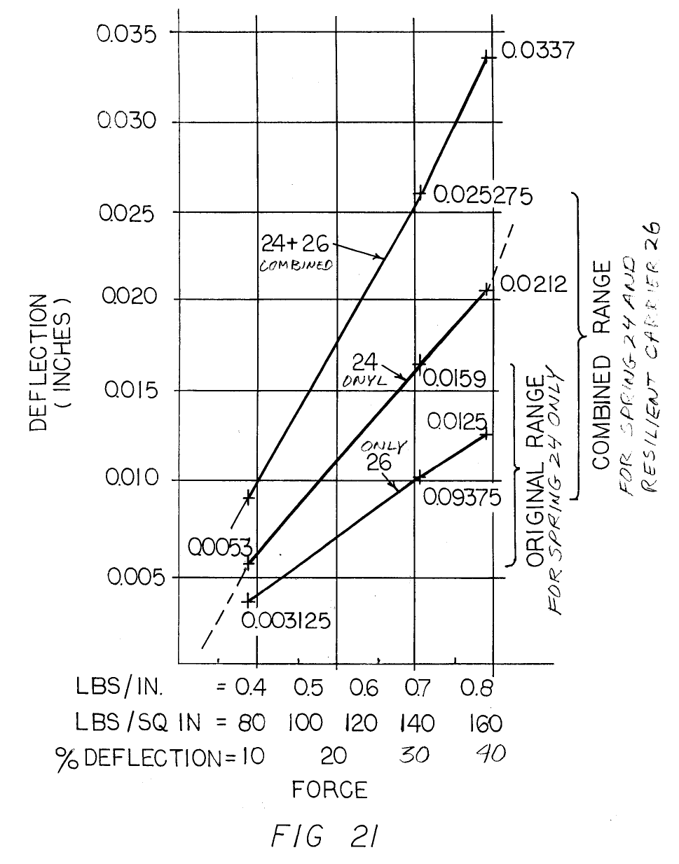

FIG. 20 shows a comparison of cant spring loads verses cant spring deflection values (or compression) for a typical prior art cant spring as manufactured by Bal Seal. Specifically, FIG. 20 shows: (1) the spring force generated by deflection, or compression, of the cant spring height (the spring force is shown in pounds of force generated by each one inch of spring running length, and spring deflection is shown in inches of deflection from the original uncompressed cant spring height); (2) seal face contact pressure generated by deflection, or compression, of the cant spring height (seal face contact pressure is shown in pounds per square inch as would be applied at the seal contact face area); and (3) the percent reduction in cant spring height (shown as a percentage of the original uncompressed cant spring height) resulting from deflection, or compression, of the cant spring. As shown in FIG. 20, the manufacturer's recommended cant spring working range, or allowable deflection range is limited to cant spring deflections, or height reductions, of values between 10% and 30% of the original uncompressed height of the cant spring (which had an uncompressed height of 0.053 inches). This limited the working range of the cant spring height from 0.0477 inches (which is 90% of the total of the original uncompressed cant spring height) to 0.0371 inches (which is 70% of the total of the original uncompressed cant spring height; or, provided a maximum cant spring compression range or spring deflection, of 0.0159 inches (for the manufacturers recommended limit of a maximum 30% reduction or deflection, in overall cant spring height at it's full loading condition).

FIG. 21 shows a similar comparison of seal loads verses seal deflections for a commensurate seal assembly which utilizes a resilient carrier as an active component of the seal. Specifically, FIG. 21 shows a comparison of (1) the compression force generated (in pounds of force per running inch); (2) the sealing force generated (in pounds of force applied to each square inch of the seal contact face or area) and (3) the height deflections (shown in percent of the original uncompressed height) resulting from compression of the resilient carrier 26, the spring 24 or compression member 24, and the combination of both the resilient carrier 26 combined with the spring 24 or compression member 24. As shown in FIG. 21, the addition of a resilient compressible carrier 26 (e.g., a rubber resilient compressible carrier as shown in FIG. 18) provided a significant increase in the range of deflections that can be accommodated by the seal assembly which utilizes the combined loads produced by the compression of both the resilient carrier 24 and the spring 26 or compression member to provide the seal 22 loading without exceeding the recommended working range (as specified by the manufacturer) of the cant spring. Specifically, the working range (allowable defections) provided by the cant spring (from 0.0053 inches @ 0.4 pounds of load to 0.0159 inches at 0.7 pounds of load) has been significantly increased (from 0.008425 inches at 0.4 pounds of load to 0.0253 inches at 0.7 pounds of load) when using the resilient compressible carrier. This allows a more than 50% increase in the overall range of travel which can be accommodated by the new seal configuration while still limiting the cant spring travel, or deflection, to the original manufacturers recommended limits.

Testing of the assembled seal assembly 20 indicated that the seal assembly 20 would perform well even when seal loading and the associated cant spring loads and cant spring deflection values were allowed to exceed the cant spring manufactures original 30% deflection operational guidelines (or deflection limits). Specifically, the testing indicated that loads that resulted in cant spring deflections greater than 40% could be accommodated, when the cant spring was used in combination with the resilient compressible carrier 26, with full recovery of both the cant spring and the resilient compressible carrier 26. This will allow, as shown in FIG. 21, total seal deflections (when including the combination of both the cant spring and the resilient compressible carrier 26 deflections), to be as high as 0.0337 inches, which is a value that is more than 2 times the deflection allowed without the benefit of using the resilient compressible carrier 26.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A seal assembly for installation into a generally elongated U-shaped seal recess or seal housing, comprising in combination:
a seal;
a compression spring or compression member supporting said seal; and
a resilient compressible carrier which houses and supports the seal and compression spring or compression member.

2. A seal assembly comprising means for utilizing a resilient carrier, containing a seal and compression spring or compression member, to enhance the load capacity or load range of the seal assembly.

3. A seal assembly comprising means for utilizing a resilient carrier, containing a seal and compression spring or compression member to enhance the available load deflection range of the seal assembly.

4. A seal assembly comprising means for utilizing a resilient carrier, containing a seal and compression spring or compression member to enhance the load capacity range and load deflection range of the seal assembly by employing the compression spring compression member and the resilient carrier to provide seal loading force and to allow seal deflection when under load, whereby the seal assembly accommodates either greater wear of the contact surfaces of the seal without exceeding predefined spring or compression member deflection limitations or accommodates larger tolerances in the fabrication, assembly, installation, and operation of the seal assembly, the U shaped seal recess or seal housing, and the machining of the adjacent sealing surfaces.

5. A seal assembly comprising means for utilizing the sealing properties of a resilient carrier, containing a seal and compression spring or compression member to reduce fluid leakage under or around the backside of the seal and seal assembly or through the compression spring or compression member.

6. A seal assembly comprising means for utilizing the physical properties of a resilient carrier, containing a seal and compression spring or compression member to adjust in real time the loading or deflection characteristics of the seal assembly based on at least one physical condition of pressure, temperature, density or concentration of the working fluids exposed to the seal assembly.

7. A seal assembly comprising means for utilizing a resilient carrier to house and retain a seal and a compression spring or compression member to enhance assembly, installation, removal or handling operations whereby the seal assembly may be installed or removed as a single end item without the use of specialized fittings or tooling.

8. A seal assembly comprising means for utilizing a resilient carrier to house and retain a seal and a compression spring or compression member to enhance assembly, installation, removal or handling operations whereby the seal assembly may be preassembled during manufacturing thereof and subsequently used fully-assembled to eliminate individual assembly, installation, removal or handling operations of the carrier, seal or compression spring or compression member during installation, removal, repair or servicing of the end in which the seal is installed.

9. An expander driver having a scroll, or scrolls, with an upper edge including the recess comprising a generally U-shaped elongated seal recess or seal housing in combination with the seal assembly as set forth in claims 1, 2, 3, 4, 5, 6, 7, 8, 47, 48, 49, 50, 51, 52, 53, 54, 55 or 56.

10. An engine having a ring land including the recess comprising a generally U-shaped elongated seal recess or seal housing in combination with the seal assembly as set forth in claims 1, 2, 3, 4, 5, 6, 7, 8, 47, 48, 49, 50, 51, 52, 53, 54, 55 or 56.

11. A ducted fan having a case and a rotating duct, one of which including the recess comprising a generally U-shaped elongated seal recess or seal housing in combination with the seal assembly as set forth in claims 1, 2, 3, 4, 5, 6, 7, 8, 47, 48, 49, 50, 51, 52, 53, 54, 55 or 56.

12. A compressor having a case and a rotating impeller, one of which including the recess comprising a generally U-shaped elongated seal recess or seal housing in combination with the seal assembly as set forth in claims 1, 2, 3, 4, 5, 6, 7, 8, 47, 48, 49, 50, 51, 52, 53, 54, 55 or 56.

13. A pair of connected pipes, one of which including the recess comprising a generally U-shaped elongated seal recess or seal housing in combination with the seal assembly as set forth in claims 1, 2, 3, 4, 5, 6, 7, 8, 47, 48, 49, 50, 51, 52, 53, 54, 55 or 56.

14. The seal assembly as set forth in claims 1, 2, 3, 4, 5, 6, 7, 8, 47, 48, 49, 50, 51, 52, 53, 54, 55 or 56 wherein said seal comprises a generally rectangular cross-sectional configuration.

15. The seal assembly as set forth in claims 1, 2, 3, 4, 5, 6, 7, 8, 47, 48, 49, 50, 51, 52, 53, 54, 55 or 56 wherein said seal is composed of a high-performance homogeneous bearing material.

16. The seal assembly as set forth in claims 1, 2, 3, 4, 5, 6, 7, 8, 47, 48, 49, 50, 51, 52, 53, 54, 55 or 56 wherein said seal is composed of a high-performance homogeneous material sold under the registered trademark “Rulon” by the Saint-Gobain Performance Plastics Corporation.

17. The seal assembly as set forth in claims 1, 2, 3, 4, 5, 6, 7, 8, 47, 48, 49, 50, 51, 52, 53, 54, 55 or 56 wherein the combined forces produced by the compression of both the said compression spring or compression member and the resilient carrier are utilized to exert a force against said seal to urge it into sealing engagement with a complementary surface to achieve a desired seal.

18. The seal assembly as set forth in claims 1, 2, 3, 4, 5, 6, 7, 8, 47, 48, 49, 50, 51, 52, 53, 54, 55 or 56 wherein said spring or compression member comprises a horizontal coil [cant] spring.

19. The seal assembly as set forth in claims 1, 2, 3, 4, 5, 6, 7, 8, 47, 48, 49, 50, 51, 52, 53, 54, 55 or 56 wherein said spring or compression member comprises a wave spring.

20. The seal assembly as set forth in claims 1, 2, 3, 4, 5, 6, 7, 8, 47, 48, 49, 50, 51, 52, 53, 54, 55 or 56 wherein said spring or compression member comprises a V-shaped spring.

21. The seal assembly as set forth in claims 1, 2, 3, 4, 5, 6, 7, 8, 47, 48, 49, 50, 51, 52, 53, 54, 55 or 56 wherein said spring or compression member comprises a U-shaped spring.

22. The seal assembly as set forth in claims 1, 2, 3, 4, 5, 6, 7, 8, 47, 48, 49, 50, 51, 52, 53, 54, 55 or 56 wherein said spring or compression member comprises a W-shaped spring.

23. The seal assembly as set forth in claims 1, 2, 3, 4, 5, 6, 7, 8, 47, 48, 49, 50, 51, 52, 53, 54, 55 or 56 wherein said spring or compression member comprises a round configuration.

24. The seal assembly as set forth in claims 1, 2, 3, 4, 5, 6, 7, 8, 47, 48, 49, 50, 51, 52, 53, 54, 55 or 56 wherein said spring or compression member comprises a rectangular configuration.

25. The seal assembly as set forth in claims 1, 2, 3, 4, 5, 6, 7, 8, 47, 48, 49, 50, 51, 52, 53, 54, 55 or 56 wherein said spring or compression member comprises a triangular configuration.

26. The seal assembly as set forth in claims 1, 2, 3, 4, 5, 6, 7, 8, 47, 48, 49, 50, 51, 52, 53, 54, 55 or 56 wherein said spring or compression member comprises a trimmed triangular configuration.

27. The seal assembly as set forth in claims 1, 2, 3, 4, 5, 6, 7, 8, 47, 48, 49, 50, 51, 52, 53, 54, 55 or 56 wherein said spring or compression member comprises s solid configuration.

28. The seal assembly as set forth in claims 1, 2, 3, 4, 5, 6, 7, 8, 47, 48, 49, 50, 51, 52, 53, 54, 55 or 56 wherein said spring or compression member comprises a hollow configuration.

29. The seal assembly as set forth in claims 1, 2, 3, 4, 5, 6, 7, 8, 47, 48, 49, 50, 51, 52, 53, 54, 55 or 56 wherein said carrier comprises a generally U-shaped configuration dimensioned to fit within the U-shaped seal recess or seal housing and used to receive said compression spring or compression member and said seal.

30. The seal assembly as set forth in claims 1, 2, 3, 4, 5, 6, 7, 8, 47, 48, 49, 50, 51, 52, 53, 54, 55 or 56 wherein said carrier comprises a generally square cross-section.

31. The seal assembly as set forth in claims 1, 2, 3, 4, 5, 6, 7, 8, 47, 48, 49, 50, 51, 52, 53, 54, 55 or 56 wherein said carrier comprises a rectangular cross-section.

32. The seal assembly as set forth in claims 1, 2, 3, 4, 5, 6, 7, 8, 47, 48, 49, 50, 51, 52, 53, 54, 55 or 56 wherein said carrier comprises a V-shaped cross-section.

33. The seal assembly as set forth in claims 1, 2, 3, 4, 5, 6, 7, 8, 47, 48, 49, 50, 51, 52, 53, 54, 55 or 56 wherein said carrier comprises a U-shaped cross-section.

34. The seal assembly as set forth in claims 1, 2, 3, 4, 5, 6, 7, 8, 47, 48, 49, 50, 51, 52, 53, 54, 55 or 56 wherein said carrier comprises a half-round cross-section.

35. The seal assembly as set forth in claims 1, 2, 3, 4, 5, 6, 7, 8, 47, 48, 49, 50, 51, 52, 53, 54, 55 or 56 wherein said carrier is composed of a resilient compressible material to provide additional support and an increased range of travel to said seal.

36. The seal assembly as set forth in claims 1, 2, 3, 4, 5, 6, 7, 8, 47, 48, 49, 50, 51, 52, 53, 54, 55 or 56 wherein said carrier is positioned between the U-shaped seal recess or seal housing and said compression spring or compression member.

37. The seal assembly as set forth in claims 1, 2, 3, 4, 5, 6, 7, 8, 47, 48, 49, 50, 51, 52, 53, 54, 55 or 56 wherein said carrier is positioned between said compression spring or compression member and said seal.

38. The seal assembly as set forth in claims 1, 2, 3, 4, 5, 6, 7, 8, 47, 48, 49, 50, 51, 52, 53, 54, 55 or 56 wherein said carrier comprises a generally U-shaped cross-sectional configuration that is positioned below said compression spring or compression member.

39. The seal assembly as set forth in claims 1, 2, 3, 4, 5, 6, 7, 8, 47, 48, 49, 50, 51, 52, 53, 54, 55 or 56 wherein said carrier comprises a generally U-shaped cross-sectional configuration that is positioned above said compression spring or compression member.

40. The seal assembly as set forth in claims 1, 2, 3, 4, 5, 6, 7, 8, 47, 48, 49, 50, 51, 52, 53, 54, 55 or 56 wherein said carrier comprises a generally rectangular cross-sectional configuration that is positioned above said compression spring or compression member.

41. The seal assembly as set forth in claims 1, 2, 3, 4, 5, 6, 7, 8, 47, 48, 49, 50, 51, 52, 53, 54, 55 or 56 wherein said carrier comprises a generally rectangular cross-sectional configuration that is positioned below said compression spring or compression member.

42. The seal assembly as set forth in claims 1, 2, 3, 4, 5, 6, 7, 8, 47, 48, 49, 50, 51, 52, 53, 54, 55 or 56 further including at least two compression springs or compression members.

43. The seal assembly as set forth in claims 1, 2, 3, 4, 5, 6, 7, 8, 47, 48, 49, 50, 51, 52, 53, 54, 55 or 56 further including at least two carriers.

44. The seal assembly as set forth in claims 1, 2, 3, 4, 5, 6, 7, 8, 47, 48, 49, 50, 51, 52, 53, 54, 55 or 56 further including at least two said seals with their respective said compression springs or compression members and carriers positioned within the U-shaped seal recess or seal housing.

45. The seal assembly as set forth in claims 1, 2, 3, 4, 5, 6, 7, 8, 47, 48, 49, 50, 51, 52, 53, 54, 55 or 56 further including at least two said seals and their respective said compression springs or compression members are positioned within a single U-shaped seal recess or seal housing.

46. The seal assembly as set forth in claims 1, 2, 3, 4, 5, 6, 7, 8, 47, 48, 49, 50, 51, 52, 53, 54, 55 or 56 further including at least two said seals supported by a single said compression spring or compression member within a single carrier.

47. A method for enhancing the working range of a multimember extended range compression seal comprising the steps of:
positioning an elongated seal onto at least two stacked layers of elongated compression springs or compression members and an elongated resilient compressible carrier;
installing the elongated seal and the stacked layers of an elongated compression spring or compression member and an elongated resilient compressible carrier into a generally U-shaped elongated seal recess or seal housing; and
selecting the material composition of each of the compression springs or compression members and carriers to have desired expansion ratios and compressibility factors to thereby adjust the seal loading pressure basis upon a wider range of working fluid conditions or seal carrier conditions.

48. A method for enhancing the working range of a multimember extended range compression seal comprising the steps of:
positioning an elongated seal onto at least two stacked layers of elongated compression springs or compression members and an elongated resilient compressible carrier;
installing the elongated seal and the stacked layers of elongated compression springs or compression members and an elongated resilient compressible carrier into a generally U-shaped elongated seal recess or seal housing; and
selecting the material composition of each of the compression springs or compression members and resilient carriers to have desired seal pressure based upon the changes encountered in the seal working environment thereby maintaining a high quality seal with optimum seal contact pressures under specific working conditions while providing a relaxed or no seal when the selected working conditions do not exist.

49. The method as set forth in claim 38, wherein the changes encountered in the seal working environment comprises changes in temperature, pressure, density or concentration of the working fluid.

50. The method as set forth in claim 38, wherein the changes encountered in the seal working environment is based upon the physical condition of the material which is surrounding the seal or the seal resilient carrier.

51. A seal assembly comprising means for utilizing a resilient carrier, containing a seal and compression spring or compression member, to adjust in real time the loading or deflection characteristics of the seal assembly based upon a change in the physical condition of the end item or component in which the seal is used or installed.

52. A seal assembly comprising means for utilizing a resilient carrier, containing a seal and compression spring or compression member, to allow easy adjustment, or readjustment, of seal face contact loads or contact pressure, and seal height, by replacement of the low cost resilient carrier, without having to change out, or replace, the more costly seal and compression spring or compression member components.

53. A seal assembly comprising means for utilizing a resilient carrier, containing a seal and compression spring or compression member, to maintain a constant, or nearly constant, close tolerance seal face contact load, or contact pressure, along the entire length of long, or extended length, seals.

54. A seal assembly comprising means for utilizing a resilient carrier, containing a seal and compression spring or compression member, which can maintain the constant or nearly constant, close tolerance seal face contact load, or contact pressure, when using the soft sealing materials [e.g. Rulon composites, plastics, and the like] which typically have higher wear rates than traditional seal materials.

55. A seal assembly comprising means for utilizing a resilient carrier, containing a seal and compression spring or compression member, which can accommodate the wider variations in seal manufacturing tolerances [e.g. greater variations in seal height and width dimensions] which are commonly encountered in the manufacture of the softer sealing materials [e.g. Rulon, composites, plastics, and the like] which are now being developed and used for sealing applications.

56. A seal assembly comprising means for utilizing a resilient carrier, containing a seal and compression spring or compression member, that can provide a positive means of retaining itself in the U-shaped seal recess or seal housing eliminating the need for using special installation, assembly, or retention tools or tooling or adhesives.
